(19) United States
(12) Patent Application Publication
(10) Pub. No.: US 2002/0165411 A1
(43) Pub. Date: Nov. 7, 2002

(54) Sterically hindered phosphine ligands and uses thereof

(76) Inventors: John F. Hartwig, Durham, CT (US); James Stambuli, New Haven, CT (US); Shaun Stauffer, Schwenksville, PA (US)

Correspondence Address: Docket Coordinator, WIGGIN & DANA, One Century Tower, 265 Church Street, New Haven, CT, 06508-1832, US

(21) Appl. No.: 10/013,156

(22) Filed: Dec. 10, 2001

Related U.S. Application Data
(60) Provisional application No. 60/255,057, filed on Dec. 12, 2000.

(51) Int. Cl. C07F 9/28; C07F 9/02

(52) U.S. Cl. 564/15; 568/9

(57) ABSTRACT

The present invention is directed to a catalyst composition, comprising a Group 8 metal; and a ligand having a structure selected from the group consisting of:

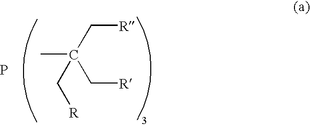

wherein R, R′ and R″ are selected from the group consisting of H, a 1-10 carbon moiety, OR₁, and NR₂R₃, wherein R₁, R₂, and R₃ are each individually a 1-10 carbon moiety, with the proviso that one of R, R′, or R″ is not H, and that R, R′, and R″ together do not form an adamantyl moiety; and

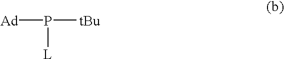

wherein L is selected from the group consisting of a 1-30 carbon moiety with a tertiary carbon bound to phosphorous The present invention is also directed to a method of forming carbon-carbon, carbon-oxygen, carbon-sulfur, and carbon-nitrogen bonds between substrates using the above catalysts.

This application claims the benefit of Provisional Application Serial No. 60/255,057 filed Dec. 12, 2000.

### STATEMENT OF GOVERNMENT SUPPORT

This invention was made in part with government support under grant number DE-FG02-96ER14678 from the Department of Energy. The Federal Government has certain rights in this invention.

### BACKGROUND OF THE INVENTION

1. Field of the Invention

This invention relates to phosphine ligands and uses therefor, and in particular to sterically hindered adamantyl and aliphatic phosphine ligands and their uses as catalysts in carbon-nitrogen, carbon-oxygen, carbon-sulfur, and carbon-carbon bond formation.

2. Description of the Related Art

Mild arylation and amination reactions to form C—C, C—N, C—O and C—S bonds are difficult transformations. For reactions of unactivated aryl halides, direct, uncatalyzed substitutions and copper-mediated couplings typically require temperatures of 100° C. or greater (Bacon, R. G. R.; Rennison, S. C. J. Chem. Soc. (C) 1969, 312-315; Marcoux, J. F.; Doye, S.; Buchwald, S. L. J. Am. Chem. Soc. 1997, 119, 10539-10540; Kalinin, A. V.; Bower, J. F.; Riebel, P.; Snieckus, V. J. Org. Chem. 1999, 64, 2986-2987).

Alternative approaches have suffered similar drawbacks and disadvantages. For example, diazotization and displacement with oxygen or nitrogen nucleophiles is generally limited in scope and uses stoichiometric amounts of copper in its mildest form (March, J. In Advanced Organic Chemistry John Wiley and Sons: New York, 1985; pp 601). Recently, palladium catalysts for the formation of diaryl and alkyl aryl ethers from unactivated aryl halides have been shown to be useful in these reactions (Mann, G.; Incarvito, C.; Rheingold, A. L.; Hartwig, J. F. J. Am. Chem. Soc. 1999, 121, 3224-3225). However, this system for C—O bond-formation as well as similar systems (Aranyos, A.; Old, D. W.; Kiyomori, A.; Wolfe, J. P.; Sadighi, J. P.; Buchwald, S. L. J. Am. Chem. Soc. 1999, 121, 4369-4378) required temperatures similar to those for copper-mediated processes (Bacon, R. G. R.; Rennison, S. C. J. Chem. Soc. (C) 1969, 312-315; Marcoux, J. F.; Doye, S.; Buchwald, S. L. J. Am. Chem. Soc. 1997, 119, 10539-10540; Kalinin, A. V.; Bower, J. F.; Riebel, P.; Snieckus, V. J. Org. Chem. 1999, 64, 2986-2987; Boger, D. L.; Yohannes, D. J. Org. Chem. 1991, 56, 1763; Fagan, P. J.; Hauptman, E.; Shapiro, R.; Casalnuovo, A. J. Am. Chem. Soc. 2000, 122, 5043-5051). In addition, several catalysts have been shown to induce aromatic C-N bond-formation from aryl halides and sulfonates. Yet, the temperatures for general reactions remain high in many cases, and the selectivities for formation of the desired aniline derivative instead of the undesired arene or diarylamine are often lower than optimal for synthetic applications.(Wolfe, J. P.; Buchwald, S. L. J. Org. Chem. 2000, 65, 1444; Wolfe, J. P.; Buchwald, S. L. J. Org. Chem. 2000, 65, 1158; Huang, J.; Grassa, G.; Nolan, S. P. Org. Lett. 1999, 1, 1307; Hartwig, J. F.; Kawatsura, M.; Hauck, S. I.; Shaughnessy, K. H.; Alcazar-Roman, L. M. J. Org. Chem. 1999, 64, 5575; Stauffer, S. I.; Hauck, S. I.; Lee, S.; Stambuli, J.; Hartwig, J. F. Org. Lett. 2000, 2, 1423). In addition, many ligands are difficult to prepare. Finally, catalysts have been developed for aromatic or vinylic C—C bond formation, but again the conditions for these reactions are often harsh.(Suzuki, A. J. Organomet. Chem. 1999, 576, 147; Buchwals, S. L.; Fox, J. M. The Strem Chemiker, 2000, 18, 1; Zhang, C; Huang, J.; Trudell, M. L.; Nolan, S. P. J. Org. Chem. 1999, 64, 3804; Beletskaya, I. P. Cheprakov, A. V. Chem. Rev. 2000, 100, 3009; Littke, A. F.; Fu, G. C. J. Org. Chem. 1999, 64, 10; Shaughnessy, K. H.; Hartwig, J. F. J. Am. Chem. Soc. 1999, 121, 2123) In particular for each of these three classes of reactions, the bond-forming processes are especially difficult to conduct under mild conditions with high selectivity when using chloroarenes.

Unfortunately, reaction conditions such as those described above are quite harsh, making the ligands difficult to prepare and requiring special equipment and techniques to accomplish even small scale syntheses. In addition, larger scale reactions of these reactions, such as those used in large-scale pharmaceutical manufacturing, are generally impractical and expensive due to these extreme reaction conditions.

What is needed in the art is a catalyst and a method of carbon-nitrogen, carbon-oxygen, carbon-sulfur, and carbon-carbon bond formation that occurs under mild conditions (e.g., room temperature and atmospheric pressure) and that is easily scalable for large-scale synthesis, for example, in the pharmaceutical industry. The present invention is believed to be an answer to that need.

### SUMMARY OF THE INVENTION

In one aspect, the present invention is directed to a chemical compound having the structure

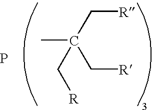

wherein R, R′ and R″ are selected from the group consisting of H, a 1-10 carbon moiety, OR₁, and NR₂R₃, wherein R₁, R₂, and R₃ are each individually a 1-10 carbon moiety, with the proviso that one of R, R′, or R″ is not H, and that R, R′, and R″ together do not form an adamantyl moiety.

In another aspect, the present invention is directed to a chemical compound having the structure

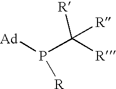

wherein R′, R″, and R″′ are selected from the group consisting of H and a 1-10 carbon moiety with the proviso that only one of R′, R″, and R″′ is H, and that R′, R″, and R″′ together do not form an adamantyl moiety, and wherein R is selected from the group consisting of a substituted or unsubstituted 1-10 carbon moiety.

In another aspect, the present invention is directed to a chemical compound having the structure

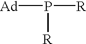

wherein R is a 1-30 carbon moiety, and wherein R is bonded to P at a tertiary carbon atom.

In another aspect, the present invention is directed to a chemical compound having the structure

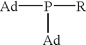

wherein R is a 1-30 carbon moiety, and wherein R is bonded to P at a tertiary carbon atom, with the provisio that R is not t-butyl.

In another aspect, the present invention is directed to a chemical compound having the structure

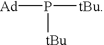

In another aspect, the present invention is directed to a catalyst composition, comprising a Group 8 metal; and a ligand having a structure selected from the group consisting of:

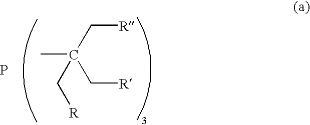

wherein R, R′ and R″ are selected from the group consisting of H, a 1-10 carbon moiety, OR₁, and NR₂R₃, wherein R₁, R₂, and R₃ are each individually a 1-10 carbon moiety, with the proviso that one of R, R′, or R″ is not H, and that R, R′, and R″ together do not form an adamantyl moiety; and

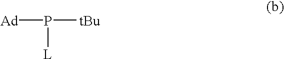

wherein L is selected from the group consisting of a 1-30 carbon moiety with a tertiary carbon bound to phosphorous.

In another aspect, the present invention is directed to a catalyst composition, comprising a Group 8 metal; and a ligand having a structure

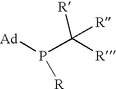

wherein R′, R″, and R″′ are selected from the group consisting of H and a 1-10 carbon moiety with the proviso that only one of R′, R″, and R″′ is H, and that R, R′, and R″ together do not form an adamantyl moiety; and wherein R is selected from the group consisting of a substituted or unsubstituted 1-10 carbon moiety.

In another aspect, the present invention is directed to a catalyst composition, comprising a Group 8 metal; and a ligand having a structure

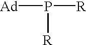

wherein R is a 1-30 carbon moiety, and wherein R is bonded to P at a tertiary carbon atom.

In another aspect, the present invention is directed to a catalyst composition, comprising a Group 8 metal; and a ligand having a structure

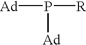

wherein R is a 1-30 carbon moiety, and wherein R is bonded to P at a tertiary carbon atom, with the provisio that R is not t-butyl.

In another aspect, the present invention is directed to a method of forming a compound having a carbon-oxygen, carbon-nitrogen, carbon-sulfur, or carbon-carbon bond, comprising the step of: reacting a first substrate and a second substrate in the presence of a transition metal catalyst and wherein the transition metal catalyst comprises a Group 8 metal and a ligand having a structure selected from the group consisting of:

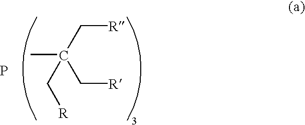

wherein R, R′ and R″ are selected from the group consisting of H, a 1-10 carbon moiety, OR₁, and NR₂R₃, wherein R₁, R₂, and R₃ are each individually a 1-10 carbon moiety, with the proviso that one of R, R′, or R″′ is not H, and that R, R′, and R″ together do not form an adamantyl moiety; and

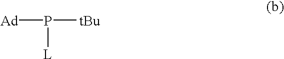

wherein L is selected from the group consisting of wherein L is selected from the group consisting of a 1-30 carbon moiety with a tertiary carbon bound to phosphorous, under reaction conditions effective to form the compound, wherein the compound comprises a carbon-oxygen, carbon-nitrogen, carbon-sulfur, or carbon-carbon bond between the first substrate and the second substrate.

These and other aspects will become evident upon reading the following detailed description of the invention.

### BRIEF DESCRIPTION OF THE FIGURES

The invention will be more fully understood from the following detailed description taken in conjunction with the accompanying figures in which:

FIG. 1 shows a schematic pathway of the synthesis of P-Ad(tBu)₂ and P-Ad₂tBu; and

FIG. 2 shows a schematic pathway of the synthesis of P(CMe₂Et)₃.

### DETAILED DESCRIPTION OF THE INVENTION

It now has been surprisingly found, in accordance with the present invention, that a solution is provided to the problem of providing a general and efficient catalytic method of carbon-nitrogen, carbon-oxygen, carbon-sulfur, and carbon-carbon bond formation between two substrates that occurs under mild conditions (e.g., room temperature to 100° C., and atmospheric pressure). The present inventors have solved this problem by utilizing a catalyst that includes a transition metal catalyst comprising a Group 8 metal and a substituted phosphine ligand. The catalyst is useful in a general and efficient process of formation of reaction products containing a carbon-carbon, carbon-oxygen, carbon-sulfur, or carbon-nitrogen bond. Production of carbon-carbon, carbon-oxygen, carbon-sulfur, or carbon-nitrogen bonds between substrates under mild conditions is particularly advantageous in the pharmaceutical industry where active starting substrates can be rapidly degraded by harsh chemical coupling conditions. The carbon-carbon, carbon-oxygen, carbon-sulfur, or carbon-nitrogen bonds are formed under mild conditions and in the presence of the catalyst using a variety of starting substrates, most notably aryl or vinyl halide reagents, aryl or vinyl sulfonate reagents, aryl diazonium salts, alkoxide reagents, siloxide reagents, alcohol reagents, silanol reagents, amine reagents, organoboron reagents, organomagnesium reagents, organozinc reagents, malonate reagents, cyanoacetate reagents, organic monocarbonyl reagents, such as ketones, esters, and amides, and olefinic reagents.

As defined herein, the term “substrate” includes distinct compounds possessing the above reactive groups (for example, aryl or vinyl halides, aryl or vinyl sulfonates, aryl diazonium salts, alkoxides, alcohols, siloxides, silanols, amines or related compounds with an N—H bond, organoborons, organomagnesiums, organozincs, malonates, cyanoesters, organic monocarbonyl reagents, such as ketones, esters, and amides, and olefinic compounds) as well as a single compound that includes reactive groups such as aryl or vinyl halides, aryl or vinyl sulfonates, aryl diazonium salts, alkoxides, alcohols, siloxides, silanols, amines or related compounds with an N—H bond, organoboron, organomagnesium, organozinc, malonate, cyanoester, organic monocarbonyl reagents, such as ketones, esters, and amides, and olefinic groups, such that an intramolecular reaction can take place in the presence of the catalyst of the present invention. As defined herein, the term “aromatic” refers to a compound whose molecules have the ring structure characteristic of benzene, naphthalene, anthracene, related heterocycles such as pyridines, pyrimidines, thiophenes, furans, pyrroles, and the like. The phrase “aromatic carbon-oxygen, carbon-nitrogen, carbon-sulfur, or carbon-carbon bond” refers to a covalent bond between a carbon atom of an aromatic or heteroaromatic ring of a first substrate, and an oxygen, nitrogen, sulfur, or carbon atom of a second substrate. The terms “amine” and “amine reagent” are broadly defined herein to encompass primary amines, secondary amines, alkyl amines, benzylic amines, aryl amines, as well as related compounds with N—H bonds, including hydrazones, hydrazines, azoles, amides, carbamates, and cyclic or heterocyclic amine compounds. The term “1-10 carbon moiety” refers to substituents containing 1-10 carbon atoms, and includes substituted or unsubstituted aliphatic moieties, such as n-ethyl, n-propyl, n-butyl, n-pentyl, n-hexyl, n-octyl, and n-decyl substituents, as well as cyclized and branched derivatives of these moieties. The term also refers to aromatic or heteroaromatic substituents containing 1-10 carbon atoms.

As indicated above, the catalyst of the present invention includes a Group 8 transition metal atom complexed with a phosphine ligand. In one embodiment, the phosphine ligand portion of the catalyst is represented by the structure (a):

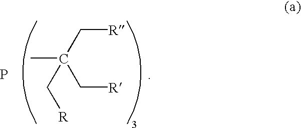

In structure (a), the substituents R, R′ and R″ may be individually H, a 1-10 carbon moiety, OR₁, and NR₂R₃, wherein R₁, R₂, and R₃ are each individually a 1-10 carbon moiety, with the proviso that one of R, R′, or R″ is not H. Moreover, R, R′, and R″ may not together form an adamantyl moiety.

In a preferred embodiment, the ligand portion of the catalyst shown in structure (a) has R and R′ as hydrogen, and R″ as methyl to give the structure

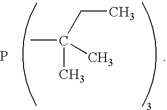

Tris-(1,1-dimethyl-propyl)-phosphine is generally synthesized by combining PCl₃ and 1,1-dimethyl-1-propylmagnesium chloride in the presence of a copper catalyst until the desired product is produced. The product may be isolated and characterized using conventional methods known in the art. The detailed synthesis is described in more detail below. Alternatively, ligands bearing alkoxy or amino groups at R, R′ or R″ could be prepared by Michael addition of the phosphine to an alpha, beta unsaturated ketone or alkylation of a phosphine with an alpha haloketone. Subsequent addition of Grignard to the ketone and alkylation of the resulting alcohol would generate alkoxy-substituted ligands. The amino compounds could be prepared by a similar procedure after converting the ketone or aldehyde to an imine. These procedures are known to those of skill in the art.

In an alternative embodiment of the present invention, the phosphine ligand portion of the catalyst is represented by the structure (b):

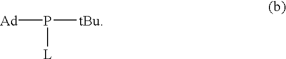

In structure (b), “Ad” refers to a substituted or unsubstituted adamantyl group having the general structure

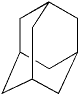

and may be bonded to the phosphorous atom at either a secondary carbon atom or a tertiary carbon atom. Various substitutions may be made at the carbon atoms in the adamantyl structure. One preferred substitution is a phenyl group at one carbon to give the structure

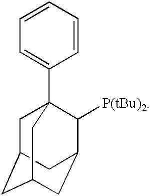

Other substitutions are known to those of skill in the art. “tBu” refers to a tertiary butyl group having the structure

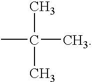

The moiety designated as “L” in structure (b) may be either Ad or tBu. Thus, in preferred embodiments, the ligand portion of the catalyst has the structure

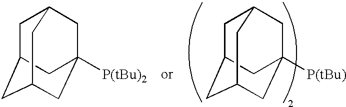

In an alternative preferred embodiment, the ligand portion of the catalyst has the structures

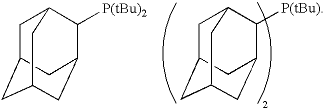

One preferred phosphine ligand includes two t-butyl groups and one adamantyl group, and is described by the general structure

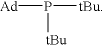

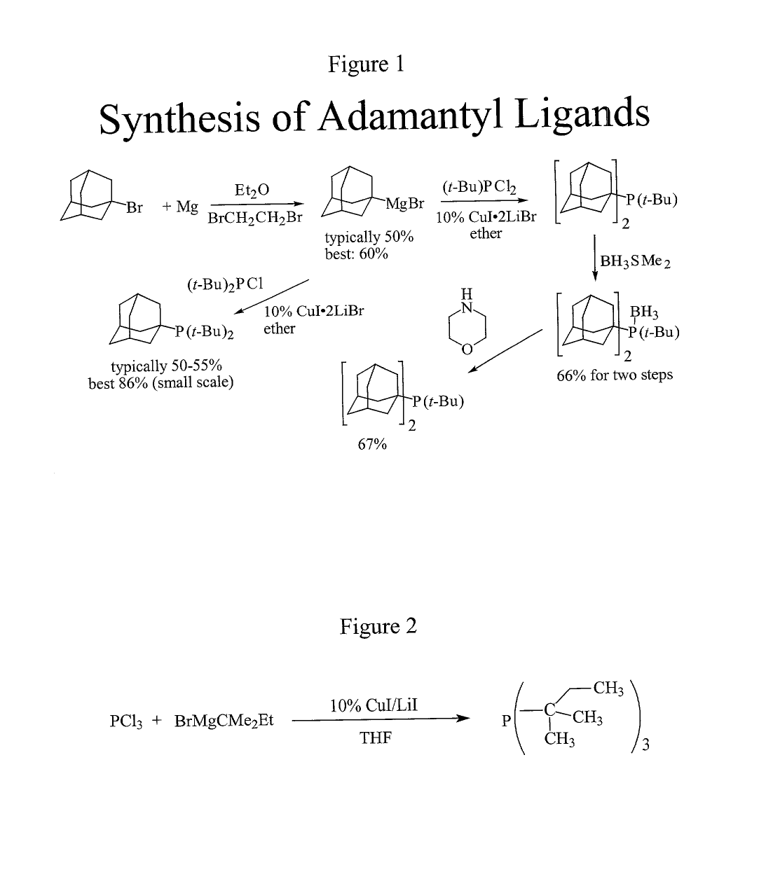

Synthesis of P-Ad(tBu)₂ and P-Ad₂tBu is shown schematically in FIG. 1. In general, either (tBu)PCl₂ or (tBu)₂PCl is reacted with adamantyl-magnesium bromide in the presence of copper iodide and lithium chloride in an ether solvent to produce the desired product. The desired product may be isolated and characterized using methods known to those of skill in the art.

In alternative embodiments, the ligand of the present invention may further have the general structure

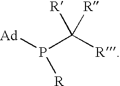

In this general structure, R′, R″, and R″′ may individually be H or a 1-10 carbon moiety, with the proviso that only one of R′, R″, and R″′ is H and that R, R′, and R″ together do not form an adamantyl moiety. Further, R is a distinct group (e.g., unbonded or uncyclized with the other substituents, and may be a substituted or unsubstituted 1-10 carbon moiety. The adamantyl moiety “Ad” may be bound to the phosphorous atom at a secondary or tertiary carbon atom.

Additional alternative embodiments for the ligand of the present invention include a chemical compound having the structure

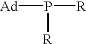

wherein R is a 1-30 carbon moiety, and wherein R is bonded to P at a tertiary carbon atom, and a chemical compound having the structure

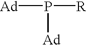

wherein R is a 1-30 carbon moiety, and wherein R is bonded to P at a tertiary carbon atom, with the provisio that R is not t-butyl.

The transition metal atom or ion used in the production of the active catalyst is required to be a Group 8 transition metal, that is, a metal selected from iron, cobalt, nickel, ruthenium, rhodium, palladium, osmium, iridium, and platinum. More preferably, the Group 8 metal is palladium, platinum, or nickel, and most preferably, palladium. The Group 8 metal may exist in any oxidation state ranging from the zero-valent state to any higher variance available to the metal.

In the presence of a Group 8 metal, such as iron, cobalt, nickel, ruthenium, rhodium, palladium, osmium, iridium, or platinum, the phosphine ligand is formed into an active catalyst that is useful in catalyzing reactions that form carbon-oxygen, carbon-nitrogen, carbon-sulfur, or carbon-carbon bonds between the substrates.

The transition metal catalyst of the invention may be synthesized first and thereafter employed in the reaction process. Alternatively, the catalyst can be prepared in situ in the reaction mixture. If the latter mixture is employed, then a Group 8 catalyst precursor compound and the phosphine ligand are independently added to the reaction mixture wherein formation of the transition metal catalyst occurs in situ. Suitable precursor compounds include alkene and diene complexes of the Group 8 metals, preferably, di(benzylidene)acetone (dba) complexes of the Group 8 metals, as well as, monodentate phosphine complexes of the Group 8 metals, and Group 8 carboxylates or halides. In the presence of the phosphine ligand, in situ formation of the transition metal catalyst occurs. Non-limiting examples of suitable precursor compounds include [bis-di(benzylidene)acetone]palladium (0), tris-[di(benzylidene)acetone]palladium (0), tris-[di(benzylidene) acetone]-dipalladium (0), palladium acetate, palladium chloride, and the analogous complexes of iron, cobalt, nickel, ruthenium, rhodium, osmium, iridium, and platinum.

Any of the aforementioned catalyst precursors may include a solvent of crystallization. Group 8 metals supported on carbon, preferably, palladium on carbon, can also be suitably employed as a precursor compound. Preferably, the catalyst precursor compound is bis-[di(benzylidene)acetone] palladium(0).

As indicated above, the present invention is also directed to a method of forming a compound having an carbon-carbon, carbon-oxygen, carbon-sulfur, or carbon-nitrogen bond, comprising the step of reacting a first substrate and a second substrate in the presence of the transition metal catalyst described above. Each of these steps and components are described in more detail below.

The first substrate useful in the method of the present invention includes aryl halide reagents, aryl sufonate reagents, aryl diazonium salts, vinyl halide reagents, vinyl sulfonate reagents, and combinations thereof.

Aryl halides, aryl sulfonates, and aryl diazonium salts that are useful as reagents include any compounds in which a halide atom, sulfonate group, or diazonium group is covalently bound to an aryl ring structure, such as a benzene ring or a heteroaromatic ring. Nonlimiting examples of suitable aryl halide reagents include bromobenzene, chlorobenzene, methoxy bromo- or chlorobenzene, bromo- or chloro toluene, bromo- or chloro benzophenone, bromo- or chloro nitrobenzene, halopyridines, halopyrazines, halopyrimidines, halothiophenes, halofurans, halopyrroles, halobenzothiophenes, halobenzofurans, haloindoles, and the like. The structures of several examples of useful aryl reagents are shown in Table 1 below.

TABLE 1
Aryl Reagents

| | | |
|---|---|---|
| 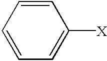 | 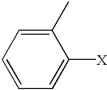 | 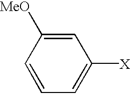 |
| 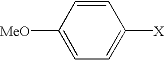 | 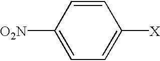 | 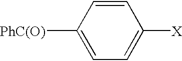 |
| 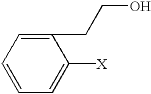 | 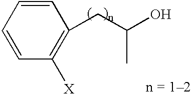 | 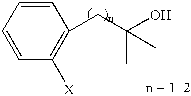 |
| 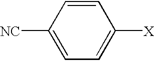 | 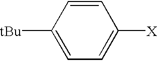 | 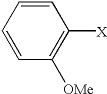 |
| 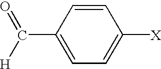 | 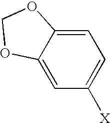 | 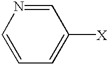 |
| 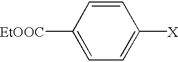 | 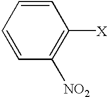 | 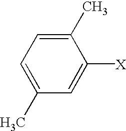 |
| 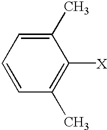 | 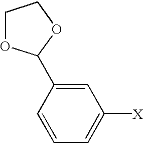 | 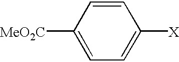 |
| 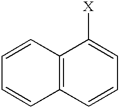 | 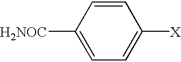 | 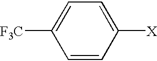 |
| 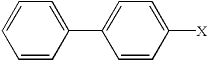 | 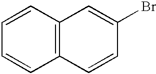 | 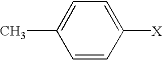 |

In each of the structures shown in Table 1, X may be any halogen, for example, bromine, chlorine, fluorine, or iodine. Additionally, X may be a sulfonate group or a diazonium group (N₂⁺), such that aryl sulfonates and aryl diazonium salts may also be used in the method of the present invention.

Vinyl halides and vinyl sulfonates may also be used in the method of the present invention. Examples of useful vinyl halides include vinylbromide, vinylchloride, α- or β-bromo- or chlorostyrene, 1- or 2-bromo- or chloropropene and longer chain variants of these vinyl halides, and cyclic vinyl halides such as bromocyclohexene, chlorocyclohexene, bromocyclopentene, chlorocyclopentene and the like. Examples of useful vinyl sulfonates include vinyltriflate, vinyltosylate, α- or β-styrenyl triflate or tosylate, 1- or 2-propenyltriflate or tosylate, and longer chain variants of these vinyl sulfonates, and cyclic vinyl sulfonates such as cyclohexenyltriflate, cyclohexenyltosylate, cyclopentenyltriflate, cyclopentenyltosylate, and the like.

As indicated above, the second substrate may be an alcohol reagent, an alkoxide reagent, a silanol reagent, a siloxide reagent, an amine reagent, an organoboron reagent, an organozinc reagent, an organomagnesium reagent such as a Grignard reagent, a malonate reagent, a cyanoacetate reagent, organic monocarbonyl reagents such as ketones, esters and amides, an olefinic reagent, or combinations of these. Nonlimiting examples of useful alkoxide reagents include NaO-C₆H₄-OMe and NaO-tBu. Nonlimiting examples of useful siloxide reagents include NaO-Si-(tBu)Me₂. Nonlimiting examples of amine reagents include primary amines, secondary amines, alkyl amines, benzylic amines, aryl amines, as well as related compounds with N—H bonds, including hydrazones, hydrazines, azoles, amides, carbamates and cyclic or heterocyclic amine compounds such as pyrrole, indole, and the like. Examples of amine and related N—H reagents that are useful in the method of the present invention include, but are not limited to, diphenylamine, benzylamine, morpholine, dibutylamine, aniline, n-butylamine, n-hexylamine, n-octylamine methylaniline, aminotoluene, t-butylcarbamate, indole, benzophenone hydrazone and benzophenone imine.

Useful organoboron reagents include arylboronic acids, such as o-tolylboronic acid, phenylboronic acid, p-trifluoromethylphenylboronic acid, p-methoxyphenylboronic acid, o-methoxyphenylboronic acid, 4-chlorophenylboronic acid, 4-formylphenylboronic acid, 2-methylphenylboronic acid, 4-methoxyphenylboronic acid, 1-naphthylboronic acid, and the like. Useful organozinc reagents include n-butylzinc chloride, secbutylzinc chloride and phenylzinc chloride. Useful organomagnesium reagents include butylmagnesium bromide and phenylmagnesium chloride. Useful organic monocarbonyl reagents include acetone, acetophenone, cyclohexanone, propiophenone, and isobutyrophenone, t-butylacetate, t-butylpropionate, methyl isobutyrate, dimethylacetamide, and N-methylpyrrolidine. Useful malonate and cyanoester reagents include dimethyl-, diethyl-, and di-t-butylmalonate, methyl and ethyl cyanoacetate. Useful olefinic reagents include vinylarenes such as styrene and acrylic acid derivatives such as n-butyl acrylate and methyl acrylate. All of these reagents may be used as the limiting substrate or in excess quantities and are preferably used in quantities of 0.2-5 equivalents relative to the aromatic halide or sulfonate.

The method of the present invention optionally takes place in the presence of a base. Any base may be used so long as the process of the invention proceeds to the product. Non-limiting examples of suitable bases include alkali metal hydroxides, such as sodium and potassium hydroxides; alkali metal alkoxides, such as sodium t-butoxide; metal carbonates, such as potassium carbonate, cesium carbonate, and magnesium carbonate; phosphates such as trisodium or tripotassium phosphate; alkali metal aryl oxides, such as potassium phenoxide; alkali metal amides, such as lithium amide; tertiary amines, such as triethylamine and tributylamine; (hydrocarbyl)ammonium hydroxides, such as benzyltrimethylammonium hydroxide and tetraethylammonium hydroxide; and diaza organic bases, such as 1,8-diazabicyclo[5.4.0]-undec-7-ene and 1,8-diazabicyclo-[2.2.2.]-octane, and organic or alkali metal fluorides such as tetrabutylamonium fluoride or potassium fluoride. Preferably, the base is an alkali hydroxide, alkali alkoxide, alkali carbonate, alkali phosphate or alkali fluoride, more preferably, an alkali alkoxide, and most preferably, an alkali metal C₁₋₁₀ alkoxide.

The quantity of base which may be used can be any quantity which allows for the formation of the product. Preferably, the molar ratio of base to arylating compound ranges from about 1:1 to about 5:1, and more preferably between about 1:1 and 3:1.

As an alternative embodiment of this invention, the catalyst may be anchored or supported on a catalyst support, including a refractory oxide, such as silica, alumina, titania, or magnesia; or an aluminosilicate clay, or molecular sieve or zeolite; or an organic polymeric resin.

The quantity of transition metal catalyst which is employed in the method of this invention is any quantity which promotes the formation of the desired product. Generally, the quantity is a catalytic amount, which means that the catalyst is used in an amount which is less than stoichiometric relative to either of the substrates. Typically, the transition metal catalyst ranges from about 0.01 to about 20 mole percent, based on the number of moles of either the first substrate or the second substrate used in the reaction. Preferably, the quantity of transition metal catalyst ranges from about 0.01 to about 2 mole percent, and more preferably from about 0.1 to about 2 mole percent, based on the moles of either substrate. In addition, the ratio of phosphine ligand to Group 8 metal is preferably in the range from about 3:1 to about 0.25:1, more preferably from about 0.5:1 to about 2:1, and most preferably from about 0.8:1 to about 3:1.

The method described herein may be conducted in any conventional reactor designed for catalytic processes. Continuous, semi-continuous, and batch reactors can be employed. If the catalyst is substantially dissolved in the reaction mixture as in homogeneous processes, then batch reactors, including stirred tank and pressurized autoclaves, can be employed. If the catalyst is anchored to a support and is substantially in a heterogeneous phase, then fixed-bed and fluidized bed reactors can be used. In the typical practice of this invention, the substrates, the catalyst, and any optional base are mixed in batch, optionally with a solvent, and the resulting mixture is maintained at a temperature and pressure effective to prepare the product.

Any solvent can be used in the process of the invention provided that it does not interfere with the formation of the product. Both aprotic and protic solvents and combinations thereof are acceptable. Suitable aprotic solvents include, but are not limited to, aromatic hydrocarbons, such as toluene and xylene, chlorinated aromatic hydrocarbons, such as dichlorobenzene, and ethers, such as dimethoxyethane, tetrahydrofuran or dioxane. Suitable protic solvents include, but are not limited to, water and aliphatic alcohols, such as ethanol, isopropanol, and cyclohexonol, as well as glycols and other polyols. The amount of solvent which is employed may be any amount, preferably an amount sufficient to solubilize, at least in part, the reactants and base. A suitable quantity of solvent typically ranges from about 1 to about 100 grams solvent per gram reactants. Other quantities of solvent may also be suitable, as determined by the specific process conditions and by the skilled artisan.

Generally, the reagents may be mixed together or added to a solvent in any order. Air is preferably removed from the reaction vessel during the course of the reaction, however this step is not always necessary. If it is desirable or necessary to remove air, the solvent and reaction mixture can be sparged with a non-reactive gas, such as nitrogen, helium, or argon, or the reaction may be conducted under anaerobic conditions. The process conditions can be any operable conditions which yield the desired product. Beneficially, the reaction conditions for this process are mild. For example, a preferred temperature for the process of the present invention ranges from about ambient, taken as about 22° C., to about 150° C., and preferably, from about 25° C. to about 100° C. The process may be run at subatmospheric pressures if necessary, but typically proceeds sufficiently well at about atmospheric pressure. The process is generally run for a time sufficient to convert as much of the substrates to product as possible. Typical reaction times range from about 30 minutes to about 24 hours, but longer times may be used if necessary.

The product can be recovered by conventional methods known to those skilled in the art, including, for example, distillation, crystallization, sublimation, and gel chromatography. The yield of product will vary depending upon the specific catalyst, reagents, and process conditions used. For the purposes of this invention, “yield” is defined as the mole percentage of product recovered, based on the number of moles of starting reactants employed. Typically, the yield of product is greater than about 25 mole percent. Preferably, the yield of product is greater than about 60 mole percent, and more preferably, greater than about 75 mole percent.

### EXAMPLES

The following examples are intended to illustrate, but in no way limit the scope of the present invention. All parts and percentages are by weight and all temperatures are in degrees Celsius unless explicitly stated otherwise.

A. Synthesis of Aliphatic Phosphine Ligands

### Example 1

### Tris-(1,1-dimethyl-1-propyl)-phosphine

Tris-(1,1-dimethyl-propyl)-phosphine was synthesized as follows. Under a nitrogen atmosphere, 0.50 mL (5.7 mmol) of PCl₃ and 30 mL of ether were added to Schlenk flask. The flask was stirred and cooled to 0°0 C. while 28 mL of a 1.0 M solution of 1,1-dimethylpropylmagnesium chloride was added dropwise from a syringe. The reaction mixture immediately turned cloudy. After stirring continued at 0° C. for 1 h, a 5 mL tetrahydrofuran solution of 109 mg (0.572 mmol) of copper (I) iodide and 100 mg (1.15 mmol) of lithium bromide, was added to the reaction. The reaction was removed from the ice bath and stirred for 17 h at 40° C. The solvent was evaporated under vacuum, and the residue was dissolved in ether and filtered through a pad of Celite. The filtrate was collected, and the ether was removed under vacuum. Distillation of the residue (122-126° C., 1 Torr) under a nitrogen atmosphere afforded 0.567 g (40.5%) of a clear oil. ¹H NMR (400 MHz, C₆D₆): δ0.99 (t, J=7.6 Hz, 9H), 1.24 (d, J=8.8 Hz, 18H), 1.69 (m, 6H). ³¹P NMR (202 MHz, C₆D₆): δ47.8.

B. Synthesis of Adamantyl Phosphane Ligands

### Example 2

### 1-adamantyl-di(tert)-butyl phosphane

Synthesis of 1-adamantyl-di(tert)-butyl phosphane (P-Ad(tBu)₂) and di-(1-adamantyl)-tert-butyl phosphane (P-Ad₂tBu) is shown schematically in FIG. 1. In a drybox, 0.520 g (2.88 mmol) of C1P(t-Bu)₂, 53 mg (0.28 mmol) of copper(I) iodide, 48 mg (0.56 mmol) of lithium bromide and 10 mL of ether were combined in a Schlenk flask, removed from the dry box and put under nitrogen. The flask was stirred and cooled to 0° C. while 12 mL of a 0.48 M solution of 1-adamantyl-magnesium bromide (Molle, G.; Bauer, P.; Dubois, J. E. J. Org. Chem. 1982, 47, 4120-4128) was added dropwise from a cannula. The reaction mixture immediately turned purple. The reaction was removed from the ice bath and stirred for 17 h at room temperature. The solvent was evaporated under vacuum, and the residue was dissolved in benzene and filtered through a pad of Celite. The filtrate was collected, and the benzene was removed under vacuum. Distillation of the solid residue (159-165° C., 1 Torr) under a nitrogen atmosphere afforded 0.696 g (86.4%) of a white solid. ¹H NMR (400 MHz, C₆D₆): δ1.32 (d, J−9.6 Hz, 18H), 1.66 (br, 6H), 1.86 (br, 3H), 2.14 (br, 6H). ³¹P NMR (202 MHz, C₆D₆): δ63.0. Anal. Calcd for C₁₈H₃₃P: C: 77.09, H: 11.86. Found: C: 77.09, H: 11.77.

### Example 3

### Di-(1-adamantyl)-tert-butyl phosphane

Di-(1-adamantyl)-tert-butyl phosphane was synthesized as follows. In a drybox, a 250 mL 2-neck round bottom flask was charged with Cl₂P(t-Bu) (1.831 g, 11.52 mmol), Cul (240 mg, 1.26 mmol), LiBr (218 mg, 2.52 mmol) and 25 mL of ether. The flask was sealed with a septum and removed from the drybox and attached to a nitrogen line. The septum was replaced by a condenser, and the reaction was cooled to 0° C. Previously prepared 1-AdMgBr (Molle, G.; Bauer, P.; Dubois, J. E. J. Org. Chem. 1982, 47, 4120-4128), (58 mL of a 0.48 M solution, 28 mmol) was added dropwise through the septum by canula, while stirring the reaction. A white precipitate formed immediately, and the solution changed from clear to yellow. The reaction was heated at 35° C. for 20 h. The ether was evaporated on a vacuum line. The remaining yellow residue was dissolved in THF, stirred, and cooled to 0° C. BH₃ in THF (12 mL of a 1.5 M solution, 18 mmol) was added slowly to the reaction by syringe. After complete addition of the borane, the reaction was stirred for 1 h at room temperature. Any excess borane was quenched with MeOH. The remaining solvent was evaporated on a vacuum line. The crude residue was adsorbed onto a SiO₂ plug. The product was isolated by first eluting with hexanes (125 mL) to remove nonpolar impurities and then eluting with CH₂Cl₂ (200 mL). Evaporation of CH₂Cl₂ left a white solid, which was dissolved in degassed morpholine (approx. 30 mL/200 mg) and heated at 110° C. for 1 h. All volatile materials were then evaporated on a vacuum line. The crude mixture was brought into the drybox, dissolved in pentane, and filtered through a SiO₂ plug. Evaporation of pentane gave 1.25 g (30.3% yield) of a white solid. ¹H NMR (300 MHz, C₆D₆): δ1.39 (d, J=10.8 Hz, 9H), 1.69 (br m, 12H), 1.89 (br s, 6H), 2.24 (br s, 12 H) ppm. ³¹P NMR (202 MHz, C₆D₆): δ62.4 ppm. MS m/z (relative intensity, %): 358 (M+, 8).

### Example 4

### 2-Adamantyl-di(tert)-butyl phosphane

2-Adamantyl-di(tert)-butyl phosphane was synthesized and isolated in a manner similar to 1-adamantyl-di(tert)-butyl phosphane, but using 2-AdMgBr as a starting material. ¹H{³¹P} (400 MHz, C₆D₆): δ1.19 (s, 18H), 1.53-1.56 (br, 2H), 1.72-1.93 (m, 8H), 2.23-2.25 (br,d, 3H), 2.57-2.60 (br d, 2H). ³¹P NMR (202 MHz, C₆D₆): δ32.6 ppm. MS m/z (relative intensity, %): 280 (M⁺, 4).

### Example 5

### Di-tert-butyl-(1-phenyl-tricyclo[3.3.1.1.]dec-2-yl)-phosphine

Di-tert-butyl-(1-phenyl-tricyclo[3.3.1.1.]dec-2-yl)-phosphine having the structure

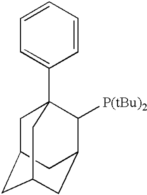

was synthesized as follows. Under a nitrogen atmosphere, a 250 mL 2-neck round bottom flask fit with a condenser, was charged with 2-Bromo-1-(phenyl)-adamantane (498 mg, 1.71 mmol) (Abdel-Sayed et al., Tetrahedron 1988, 44, 1873-1882) and 20 mL of ether. The mixture was stirred and heated to reflux while a 5 mL solution of lithium di-tert-butylphosphide (266 mg, 1.75 mmol) was added by syringe (Issleib, K.; et al., Journal Of Organometallic Chemistry 1968, 13, 283-289). The reaction was refluxed for 16 h. The ether and THF were evaporated on a vacuum line. The remaining yellow residue was dissolved in THF, stirred, and cooled to 0° C. BH₃ in THF (2.5 mL of a 1.5 M solution, 3.8 mmol) was added slowly to the reaction by syringe. After complete addition of the borane, the reaction was stirred for 1 h at room temperature. Any excess borane was quenched carefully with MeOH. The remaining solvent was evaporated on a vacuum line. The crude residue was adsorbed onto a SiO₂ plug. The product was isolated by eluting with CH₂Cl₂ (50 mL). Evaporation of CH₂Cl₂ left an off-white solid, which was recrystallized in warm hexanes. The solid was dissolved in degassed morpholine (approx. 30 mL/200 mg) and heated at 110° C. for 1 h. All volatile materials were then evaporated on a vacuum line. The crude mixture was brought into the drybox, dissolved in toluene, and filtered through a SiO₂ plug. Evaporation of toluene gave 123 mg (20.1% yield) of a white solid. ¹H NMR (400 MHz, C₆D₆): δ1.06 (d, J=9.6 Hz, 9H), 1.23 (d, J=10.4 Hz, 9H), 1.54-2.64 (m, 13H), 7.19-7.23 (m, 1H), 7.35-7.42 (m, 4H). ³¹P NMR (202 MHz, C₆D₆): δ46.2

C. Room Temperature Heck Reactions of Aryl Halides

Prior to the present invention, Heck reactions were conducted at elevated temperatures. Reports of catalyst systems labeled “highly active” involve temperatures in the range of 115-140° C. (Hermann, W. A.; Brossmer, C.; Reisinger, C.-P.; Riermeier, T. H.; Ofele, K.; Beller, M. Chem. Eur. J 1997, 3, 1357-1364; Ohff, M.; Ohff, A.; Milstein, D. Chem. Commun 1999, 357-358; Shaw, B. L.; Perera, S. D.; Staley, E. A. Chemical Communications 1998, 1361-1362; Reetz, M.; Westermann, E.; Lohmer, R.; Lohmer, G. Tetrahedron Lett. 1998, 8449-8452). Although a number of these systems produce high turnover numbers, no catalysts have been identified that operate at room temperature. Low-temperature processes are important for reactions of substrates that are less stable than the common model substrates, and room-temperature reactions are useful for parallel synthesis.

In general, the Heck reactions of the present invention proceed according to the following reaction scheme:

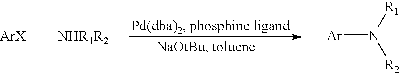

A typical procedure is given for the reaction of Example 8 in Table 2. A 4 mL vial was charged with 4-bromoanisole (187 mg, 1.00 mmol), Pd(dba)₂ (14.4 mg, 0.0250 mmol), AdP(t-Bu)₂ (0.0500 mmol), and 1 mL of anhydrous DMF. The vial was sealed with a cap containing a PTFE septum and removed from the drybox. NEt₃ (167 μL, 1.20 mmol) was added by syringe. The reaction was stirred at room temperature for 20 h. The reaction mixture was then poured into a saturated lithium chloride solution and extracted (3×10 mL) with ether. The ether was evaporated under vacuum, and the product was isolated by flash chromatography, eluting with 15% ethyl acetate/hexanes.

TABLE 2
Room Temperature Heck Reactions of Aryl Halides

| Example | ArX | Yield (%) |
|---|---|---|
| 6 | 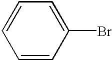 | 93 |
| 7 | 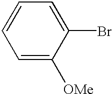 | 99 |
| 8 | 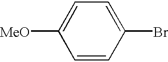 | 94 |

In Table 2, reactions were conducted on a 1 mM scale in DMF for 20 h, using 1.0 equivalent of aryl halide, 1.1 equivalent of vinyl substrate, 2.5 mol % of Pd(dba)₂, 5.0 mol % of AdP(tBu)₂ catalyst, and 1.1 equivalent of triethylamine. Isolated yields are an average of two runs.

Reactions of Aryl Halides and Amines

In general, reactions between aryl halides and amines, according to the present invention, proceed according to the following reacton scheme:

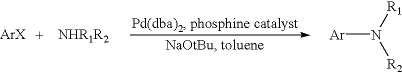

Pdba)₂ (2.9 mg, 1 mol %), tris-(1,1-dimethyl-propyl)-phosphine (1.2 mg, 1 mol %), sodium tert-butoxide (67.3 mg, 0.70 mmol), p-chlorotoluene (59.2 μL, .50 mmol) and amine (0.60-0.75mmol) were weighed directly into a screw cap vial. A stir bar was added followed by 1.0 mL of toluene. The vial was capped, removed from the drybox, and placed into an 80° C. oil bath. Reaction yields (Table 3) were either isolated (column chromatography) or determined from CG with an internal standard.

TABLE 3a
Reactions of Aryl Halides and Amines

| Ex- | | | | | |
|---|---|---|---|---|---|
| ample | Ligand | Halide | Amine | Product | Yield |
| 9 | 1 | p-chlorotoluene | Ph₂NH | Ph₂N-tol | 84% |
| 10 | 1 | p-chlorotoluene | BenzylNH₂ | benzylNH-tol | 65% |
| 11 | 1 | p-chlorotoluene | OctylNH₂ | octylNH-tol | 76% |
| 12 | 2 | p-chlorotoluene | TolNH₂ | toINH-tol | 99% |
| 13 | 2 | p-chlorotoluene | Ph₂NH | Ph₂N-tol | 95% |
| 14 | 2 | p-chlorotoluene | BenzylNH₂ | benzylNH-tol | 81% |
| 15 | 2 | p-chlorotoluene | Morpholine | morph-tol | 92% |
| 16 | 2 | p-chlorotoluene | OctylNH₂ | octylNH-tol | 61% |

In Table 3a, Ligand 1 is tris-(1,1-dimethyl-propyl)-phosphine, and Ligand 2 is di-tert-enyl-tricyclo[3.3. 1.1 .]dec-2-yl)-phosphine.

Reactions similar to Examples 9-16 were conducted using other adamantyl phosphine he results are shown in Table 3b.

TABLE 3b
Reactions of Aryl Halides and Amines

| | | | | | Yield |
|---|---|---|---|---|---|
| Example | R₁ | R₂ | Catalyst | Time (h) | (%) |
| 17 | n-octyl | H | Ad₂P(tBu) | 17 | 90 |
| 18 | Ph | Ph | Ad₂P(tBu) | 22 | 88 |
| 19 | Ph | Ph | 1-AdP(tBu)₂ | 22 | 69 |
| 20 | Ph | Ph | 2-AdP(tBu)₂ | 22 | 70 |
| 21 | p-tol | H | Ad₂P(tBu) | 22 | 89 |
| 22 | p-tol | H | 1-AdP(tBu)₂ | 22 | 87 |
| 23 | p-tol | H | 2-AdP(tBu)₂ | 22 | 84 |
| 24 | benzyl | H | Ad₂P(tBu) | 17 | 87 |

Reactions of Aryl Halides and Cyanoesters

In general, reactions between aryl halides and cyanoesters, according to the present proceed according to the following reaction scheme:

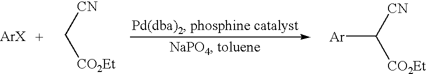

In the above reaction scheme, reactions were conducted on a 1 mmol scale in toluene using 1.1 equivalents of cyanoester, 1.0 equivalents of aryl halide, and 3 equivalents of sodium phosphate. Reactions were conducted for 96 h at room temperature. The results are shown in Table 4 using cyanoacetate as a substrate.

TABLE 4
Reactions of Aryl Halides and Cyanoesters

| Example | Ar | Catalyst | Yield (%) |
|---|---|---|---|
| 25 | C₆H₅Br | 1-AdP(tBu)₂ | 87 |
| 26 | 4-MeO—C₆H₅Br | 1-AdP(tBu)₂ | 85 |

Reactions of Aryl Halides and Monocarbonyl Compounds.

In general, reactions between aryl halides and monocarbonyl compounds, such as esters, according to the present invention, proceed according to the following reaction scheme:

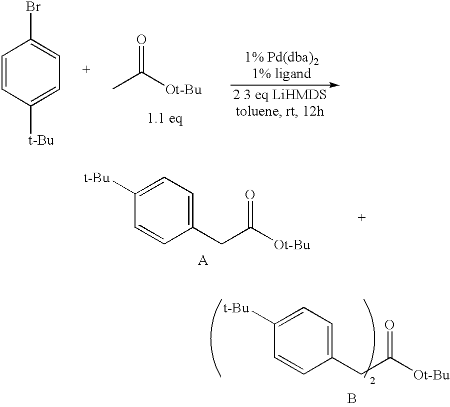

General Procedure for the arylation of t-butylacetate is as follows. To a screw-capped vial containing ligand (0.0013 mmol), Pd(dba)₂ (0.0013 mmol), and LiHMDS (0.57 mmol) was added aryl halide (0.2 mmol), ester (0.22 mmol), and 0.05 mmol of naphthalene as internal standard, followed by toluene (2.5 mL). The vial was sealed with a cap containing a PTFE septum and removed from the dry box. The heterogeneous reaction mixture was stirred at room temperature for 12 h and monitored by GC. Using this procedure, the results of several reactions are shown in Table 5.

TABLE 5
Reactions of aryl halides with t-butylacetate

GC-Yields

| Example | Ligand | Conv. | A | B |
|---|---|---|---|---|
| 27 | PCy(t-Bu)₂ | 100% | 80% | 0% |
| 28 | PCy₂(t-Bu) | 100% | 88% | 0% |
| 29 | PAd(t-Bu)₂ | 100% | 15% | 15% |
| 30 | PAd₂(n-Bu) | 100% | 84% | 0% |
| 31 | No ligand | 26% | 11% | 0% |
| 32 | No palladium | 0% | 0% | 0% |
| | No ligand | | | |

The arylation of esters can be conducted successfully with different esters. For example, the reaction can be used for the difficult formation of quaternary carbons in high yields using ligands and catalysts described in the present invention. In general, reactions between aryl halides and esters that are disubstituted in the alpha position, according to the present invention, proceed according to the following reaction scheme:

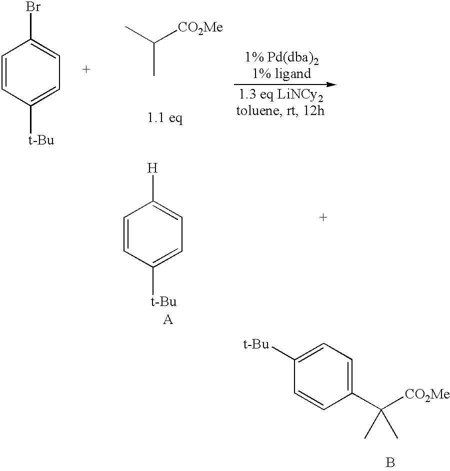

General Procedure for the arylation of methyl isobutyrate is as follows. A solution of the ester (0.22 mmol) in toluene (0.4 mL) was added to a vial containing either LiNCy₂ or NaNCy₂ (0.26 mmol.) The solution was stirred for 10 min before it was transferred to a screw cap vial containing 1 mol % of Pd(dba)₂, 0.2 mmol of aryl halide and 0.05 mmol of naphthalene as internal standard. Finally, 1 mol % ligand was added from a 0.5 M toluene stock solution. The vial was fitted with a PFTE septum and removed from the drybox. The reaction mixture was stirred at room temperature for 12 h at which time the reactions were analyzed by GC. The results of several reactions are shown in Table 6.

TABLE 6
Reactions of aryl halides with methyl isobutyrate

GC-Yields

| Example | Ligand | Conv. | A | B |
|---|---|---|---|---|
| 33 | PCy(t-Bu)₂ | 60% | 34% | 26% |
| 34 | PCy₂(t-Bu) | 58% | 21% | 37% |
| 35 | PAd₂(t-Bu) | 100% | 8% | 92% |
| 36 | PAd(t-Bu)₂ | 100% | 5% | 95% |
| 37 | PAd₂(n-Bu) | 65% | 30% | 35% |
| 38 | PAd²(t-Bu)₂ | 100% | 14% | 86% |

Using analogous procedures to those described for reaction of t-butyl acetate, ketones such as 2-methyl 3-pentanone react with aryl halides to form the product of α-arylation. The following two reactions exemplify the utility of the ligands in this invention for the arylation of

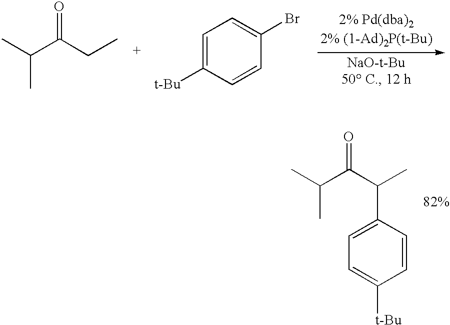

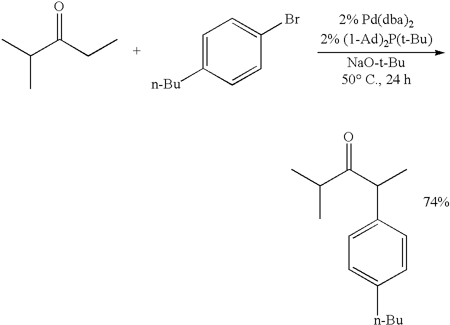

Although the invention has been shown and described with respect to illustrative embodiments thereof, it should be appreciated that the foregoing and various other changes, omissions and additions in the form and detail thereof may be made without departing from the spirit and scope of the invention as delineated in the claims. All patents, patent applications, and rated by reference in their entireties.

What is claimed is:

1. A chemical compound having the structure 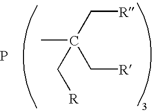
wherein R, R′ and R″ are selected from the group consisting of H, a 1-10 carbon moiety, OR₁, and NR₂R₃, wherein R₁, R₂, and R₃ are each individually a 1-10 carbon moiety, with the proviso that one of R, R′, or R″ is not H, and that R, R′, and R″ together do not form an adamantyl moiety.

2. The chemical compound of claim 1, wherein R, R′ and R″ are selected from the group consisting of H and a 1-10 carbon moiety.

3. The chemical compound of claim 1, wherein R and R′ are H, and R″ is CH₃.

4. A chemical compound having the structure 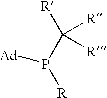
wherein R′, R″, and R′″ are selected from the group consisting of H and a 1-10 carbon moiety with the proviso that only one of R′, R″, and R′″ is H, and that R′, R″, R′″ and R″′ together do not form an adamantyl moiety, and wherein R is selected from the group consisting of a substituted or unsubstituted 1-10 carbon moiety.

5. The chemical compound of claim 4, wherein Ad is bound to P at a secondary carbon atom.

6. The chemical compound of claim 4, wherein Ad is bound to P at a tertiary carbon atom.

7. A chemical compound having the structure 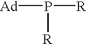
wherein R is a 1-30 carbon moiety, and wherein R is bonded to P at a tertiary carbon atom.

8. A chemical compound having the structure 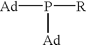
wherein R is a 1-30 carbon moiety, and wherein R is bonded to P at a tertiary carbon atom, with the provisio that R is not t-butyl.

9. A chemical compound having the structure

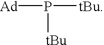

10. A catalyst composition, comprising:
a Group 8 metal; and
a ligand having a structure selected from the group consisting of: 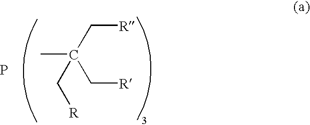
wherein R, R′ and R″ are selected from the group consisting of H, a 1-10 carbon moiety, OR₁, and NR₂R₃, wherein R₁, R₂, and R₃ are each individually a 1-10 carbon moiety, with the proviso that one of R, R′, or R″ is not H, and that R, R′, and R″ together do not form an adamantyl moiety; and 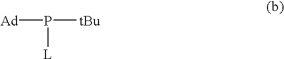
wherein L is selected from the group consisting of a 1-30 carbon moiety with a tertiary carbon bound to phosphorous.

11. The catalyst composition of claim 10, wherein in ligand (a), R, R′ and R″ are selected from the group consisting of H and a 1-10 carbon moiety.

12. The catalyst composition of claim 10, wherein in ligand (a), R and R′ are H, and R″ is CH₃.

13. The catalyst composition of claim 10, wherein in ligand (b), L is an adamantyl moiety.

14. The catalyst composition of claim 10, wherein in ligand (b), L is a tert-butyl moiety.

15. The catalyst composition of claim 10, wherein said ligand has the structure

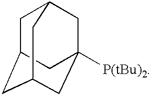

16. The catalyst composition of claim 10, wherein said ligand has the structure

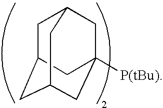

17. The catalyst composition of claim 10, wherein said ligand has the structure

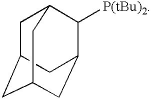

18. The catalyst composition of claim 10, wherein said ligand has the structure

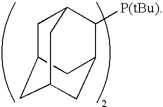

19. The catalyst composition of claim 10, wherein said Group 8 metal is selected from the group consisting of palladium, platinum, nickel, and combinations of thereof.

20. A catalyst composition, comprising:
a Group 8 metal; and
a ligand having a structure 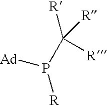
wherein R′, R″, and R′″ are selected from the group consisting of H and a 1-10 carbon moiety with the proviso that only one of R′, R″, and R′″ is H, and that R, R′, and R″ together do not form an adamantyl moiety; and wherein R is selected from the group consisting of a substituted or unsubstituted 1-10 carbon moiety.

21. A catalyst composition, comprising:
a Group 8 metal; and
a ligand having a structure 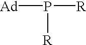
wherein R is a 1-30 carbon moiety, and wherein R is bonded to P at a tertiary carbon atom.

22. A catalyst composition, comprising:
a Group 8 metal; and
a ligand having a structure 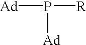
wherein R is a 1-30 carbon moiety, and wherein R is bonded to P at a tertiary carbon atom, with the provisio that R is not t-butyl.

23. A method of forming a compound having a carbon-oxygen, carbon-nitrogen, carbon-sulfur, or carbon-carbon bond, comprising the step of:
reacting a first substrate and a second substrate in the presence of a transition metal catalyst and wherein said transition metal catalyst comprises a Group 8 metal and a ligand having a structure selected from the group consisting of: 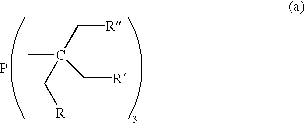
wherein R, R′ and R″ are selected from the group consisting of H, a 1-10 carbon moiety, OR₁, and NR₂R₃, wherein R₁, R₂, and R₃ are each individually a 1-10 carbon moiety, with the proviso that one of R, R′, or R″ is not H, and that R, R′, and R″ together do not form an adamantyl moiety; and 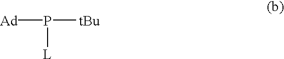
wherein L is selected from the group consisting of wherein L is selected from the group consisting of a 1-30 carbon moiety with a tertiary carbon bound to phosphorous, under reaction conditions effective to form said compound, wherein said compound comprises a carbon-oxygen, carbon-nitrogen, carbon-sulfur, or carbon-carbon bond between said first substrate and said second substrate.

24. The method of claim 23, wherein said first substrate is selected from the group consisting of aryl halide reagents, aryl sufonate reagents, aryl diazonium salts, vinyl halide reagents, vinyl sulfonate reagents, and combinations thereof.

25. The method of claim 23, wherein said first substrate is selected from the group consisting of: 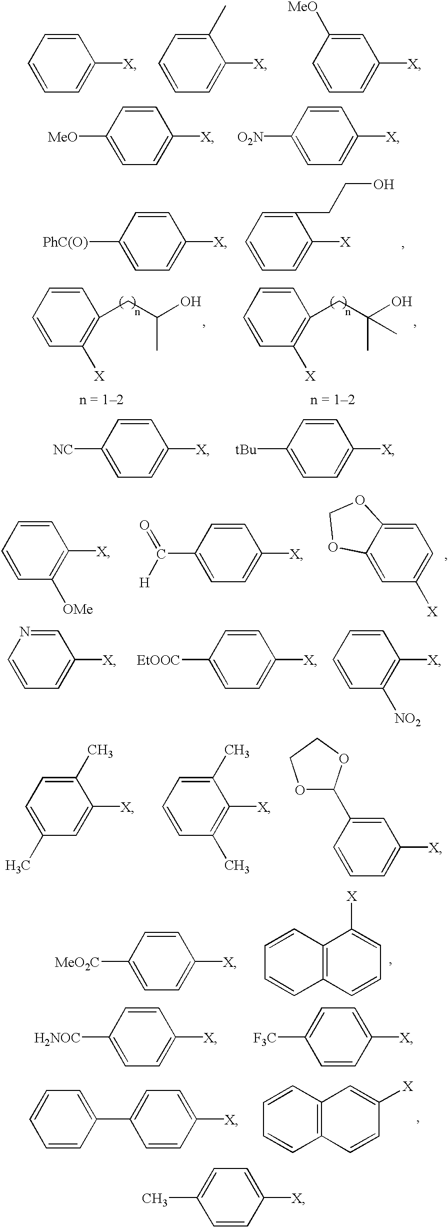
and combinations thereof, wherein X is selected from the group consisting of bromine, chlorine, fluorine, iodine, sulfonate, and diazonium.

26. The method of claim 23, wherein said first substrate is selected from the group consisting of: vinylbromide, vinylchloride, α- or β-bromo- or chlorostyrene, 1- or 2-bromo- or chloropropene, bromocyclohexene, chlorocyclohexene, bromocyclopentene, chlorocyclopentene, vinyltriflate, vinyltosylate, α- or β-styrenyl triflate or tosylate, 1- or 2-propenyl triflate or tosylate, cyclohexenyltriflate, cyclohexenyltosylate, cyclopentenyltriflate, cyclopentenyltosylate, and combinations thereof.

27. The method of claim 23, wherein said second substrate is selected from the group consisting of an alcohol reagent, an alkoxide reagent, a silanol reagent, a siloxide reagent, an amine reagent, an organoboron reagent, an organozinc reagent, an organomagnesium reagent, a malonate reagent, a cyanoester reagent, an olefinic reagent, a monocarbonyl reagent, and combinations thereof.

28. The method of claim 27, wherein said second substrate is selected from the group consisting of NaO—C₆H₄—OMe, NaO—tBu, NaO—Si—(tBu)Me₂, HO—C₆H₄—OMe, HO—tBu, HO—Si—(tBu)Me₂, morpholine, diphenylamine, benzylamine, dibutylamine, aniline, n-butylamine, n-hexylamine, n-octylamine, methylaniline, aminotoluene, organoboronic acid, indole, and combinations thereof.

29. The method of claim 27, wherein said organoboronic acid is selected from the group consisting of o-tolylboronic acid, phenylboronic acid, p-trifluoromethylphenylboronic acid, p-methoxyphenylboronic acid, o-methoxyphenylboronic acid, 4-chlorophenylboronic acid, 4-formylphenylboronic acid, 2-methylphenylboronic acid, 4-methoxyphenylboronic acid, 1-naphthylboronic acid, and combinations thereof.

30. The method of claim 27, wherein said organozinc reagent is selected from the group consisting of n-butylzinc chloride, secbutylzinc chloride, phenylzinc chloride, and combinations thereof.

31. The method of claim 27, wherein said organomagnesium reagent is selected from the group consisting of butylmagnesium bromide, phenylmagnesium chloride, and combinations thereof.

32. The method of claim 27, wherein said malonate reagent is diethyl malonate.

33. The method of claim 27, wherein said cyanoester reagent is ethyl cyanoacetate.

34. The method of claim 27, wherein said olefinic reagent is selected from the group consisting of styrene, n-butyl acrylate, methyl acrylate, and combinations thereof.

35. The method of claim 27, wherein said monocarbonyl reagent is selected from the group consisting of t-butylacetate, emthyl isobutyrate, and combinations thereof.

36. The method of claim 23, wherein in ligand (a), R, R′ and R″ are selected from the group consisting of H and a 1-10 carbon moiety.

37. The method of claim 23, wherein in ligand (a), R and R′ are H, and R″ is CH₃.

38. The method of claim 23, wherein in ligand (b), L is an adamantyl moiety.

39. The method of claim 23, wherein in ligand (b), L is a tert-butyl moiety.

40. The method of claim 23, wherein said ligand has the structure

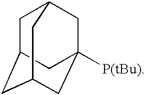

41. The method of claim 23, wherein said ligand has the structure

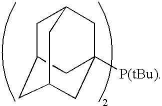

42. The method of claim 23, wherein said ligand has the structure

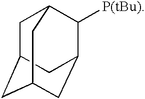

43. The method of claim 23, wherein said ligand has the structure

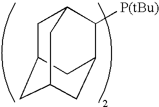

44. The method of claim 23, wherein said Group 8 metal is selected from the group consisting of palladium, platinum, nickel, and combinations of thereof.

45. The method of claim 23, wherein said reacting step further takes place in the presence of a base selected from the group consisting of alkali metal hydroxides, alkali metal alkoxides, metal carbonates, alkali metal amides, alkali metal aryl oxides, alkali metal phosphates, tertiary amines, tetraalkylammonium hydroxides, diaza organic bases, and combinations thereof.

46. The method of claim 23, wherein said transition metal catalyst is prepared from an alkene or diene complex of said Group 8 transition metal complex combined with said ligand.

47. The method of claim 46, wherein said alkene complex of the Group 8 transition metal is di(benzylidene)acetone.

48. The method of claim 23, wherein said transition metal catalyst is prepared in situ in said reaction.

49. The method of claim 23, wherein said transition metal catalyst is anchored or supported on a support.

50. The method of claim 23, wherein said reaction conditions comprise reaction times from about 30 minutes to about 24 hours, and reaction temperatures from about 22° C. to about 150° C.

51. The method of claim 23, wherein said reaction conditions further comprise a solvent selected from the group consisting of aromatic hydrocarbons, chlorinated aromatic hydrocarbons, ethers, water, aliphatic alcohols, and combinations thereof.
